(19) United States
(12) Patent Application Publication
(10) Pub. No.: US 2007/0000365 A1
(43) Pub. Date: Jan. 4, 2007

(54) Method for digital die cutter for containerboard packaging

(76) Inventors: Edwin Hirahara, Federal Way, WA (US); David L. Lee, Tacoma, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/171,156

(22) Filed: Jun. 29, 2005

(51) Int. Cl. B26D 5/20

(52) U.S. Cl. 83/76.1

(57) ABSTRACT

A digital die cutting system including at least a first addressable die cutter having a surface carrying a plurality of knives in an array, each of the knives extendable and retractable above and below the surface is presented/provided. A controller is provided for individually addressing, and extending, and retracting the knives above and below the surface. A central processing unit receives an image of a pattern to be cut by selected ones of the knives, processes that image for a controller, which then extends selected ones of the knives to correspond to the shape of the pattern. The die cutter is then presented by conventional apparatus to the surface of a panel to be die cut when at least some of the knives are extended.

### FIELD OF THE INVENTION

The present invention relates to die cutters, and more particularly, to an apparatus for replacing conventional dies for cutting and scoring paper products such as corrugated board used in containerboard packaging.

### BACKGROUND OF THE INVENTION

Corrugated cardboard comprises an inner or bottom ply and outer or top ply between which is sandwiched a third ply that is fluted. These plies are adhesively secured to each other to form a finished corrugated board. Normally, the corrugator machine produces a continuous sheet of cardboard, which is cut to produce individual sheets of board of a given size. These cardboard sheets are stacked, transported, and later fed into a box-making machine that performs two key manufacturing steps, printing and die cutting.

Typical box-making machines include, for example, a one to four color flexographic print station. Each of the stations houses a flexible printing plate and associated hardware for metering and delivering printing ink of a given color to produce text, line art, and graphics. Toward the end of the box-making machine, a die cutting unit is positioned. The purpose of the die cutting unit is to indent (create an indentation in the surface of one of the plies to assist in folding), partially cut or perforate the board, and/or completely cut the board to remove interior or peripheral portions of the board. These indentations and cuts form the finished box of proper shape (for example, tapered, rounded comers, etc.) and dimensions. Also, appropriate sections may be removed at a later time, for example, to create hand-holds and ventilation ports in the sides of the finished box.

The majority of die cutting equipment used in box plants today is of the rotary type, although a few flatbed die cutters are still in use. In both the rotary and flatbed machines, sharp knives of various shapes and lengths are inserted where needed by wedging them with a mallet into a die template made of laminated sheets of plywood. The template is routed in various places to generate the necessary grooves or channels to receive the various knives according to the box design. In a rotary die cutter, the plywood template is also curved about an axis so that it can be mounted on a steel cylinder, much like a printing plate is attached to a press cylinder. Finally, various sized pieces of foam are placed within the knife cavities or cutting zones to act like springs to provide the necessary force to eject cut pieces of board from the interior of the die cutter and to keep the cardboard panel from sticking to the die.

The tooling costs of creating a typical cutting die are relatively high, and can serve as a barrier to new product design and introduction. While the cutting die can be reused, some or all of the blades periodically need to be replaced because of wear and/or damage. Setting up the printing plates as well as maintenance and repair are all time-consuming processes that require significant machine shutdown time, thereby limiting the production capability of a line. Moreover, whenever a different box is made, the box-making machine must be stopped so that a different set of printing plates and/or associated cutting dies can be inserted in the machine. Finally, the large amount of manufacturing floor space needed to house the die inventory, die management, and care from damage all add to the cost of the workflow.

### SUMMARY OF THE INVENTION

The present invention therefore provides a solution to the labor-intensive prior methods for producing dies for cutting, indenting and scoring cardboard boxes and eliminates need for die storage and management and reduces downtime during grade changes. In accordance with the present invention, a digital die cutting system is provided comprising at least a first addressable die cutter having a surface. The die cutter has a plurality of knives arranged in an array on the surface. Each of the knives are extendable above and retractable below the surface. The system also has a controller for individually addressing, extending, setting, and retracting each of the knives above and below the surface. A central processing unit receives an image of a pattern to be cut by selected ones of the knives and processes the image into signals for the controller to extend selected ones of the knives to correspond to the shape of the pattern. Finally, a means is provided for presenting the surface of the die cutter to one surface of the panel to be die cut when at least one of the knives is extended.

In an embodiment, the addressable die cutter comprises at least a first rotary member having a cylindrically shaped surface. A plurality of knives is mounted in an array across and around the surface. Each of the knives has a blade that is extendable in a radial direction to at least a first position above the surface and is retractable below the surface. The first rotary member is mounted for rotation adjacent the path of travel for a cardboard panel to be cut or scored. This axis of rotation is oriented laterally relative to the path. In an embodiment, a second cylindrical member similar to the first member is provided. The second member is also mounted for rotation adjacent the path of travel for the panel to be cut and/or scored. The axis of rotation of the second member is oriented laterally relative to the path. The first and second cylindrical members are mounted so that the first member addresses a first side of the panel to be cut and/or scored and the second member is mounted to address the second side of the panel to be cut and/or scored.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic side view of a box-making apparatus including a printing station, a die cutting station, and an indenting station;

FIG. 2A is an isometric view of a die cutter constructed in accordance with the present invention showing the knife array with all knives retracted;

FIG. 2B shows the die cutter with selected knives extended;

FIG. 2B′ shows an indenting die with selected blades extended;

FIGS. 2C′, 2C″ and 2C′″ are enlarged views of a knife with a cutting blade;

FIGS. 2D′ and 2D″ are enlarged views of a knife with an indenting blade;

FIG. 3A is an isometric view of the pattern overlaid on a corrugated panel;

FIG. 3B is a corrugated board cut in accordance with the pattern shown in FIG. 3A;

FIG. 4 is a schematic block diagram of a digital die cutting system;

FIG. 5 is an enlarged schematic view of the die cutting station;

FIG. 6 is a view similar to FIG. 5 illustrating one manner of cutting a corrugated board; and

FIG. 7 is a partial sectional view taken through the axes of the die cutting and indenting cylinders at the die cutting and indenting stations, respectively.

### DETAILED DESCRIPTION

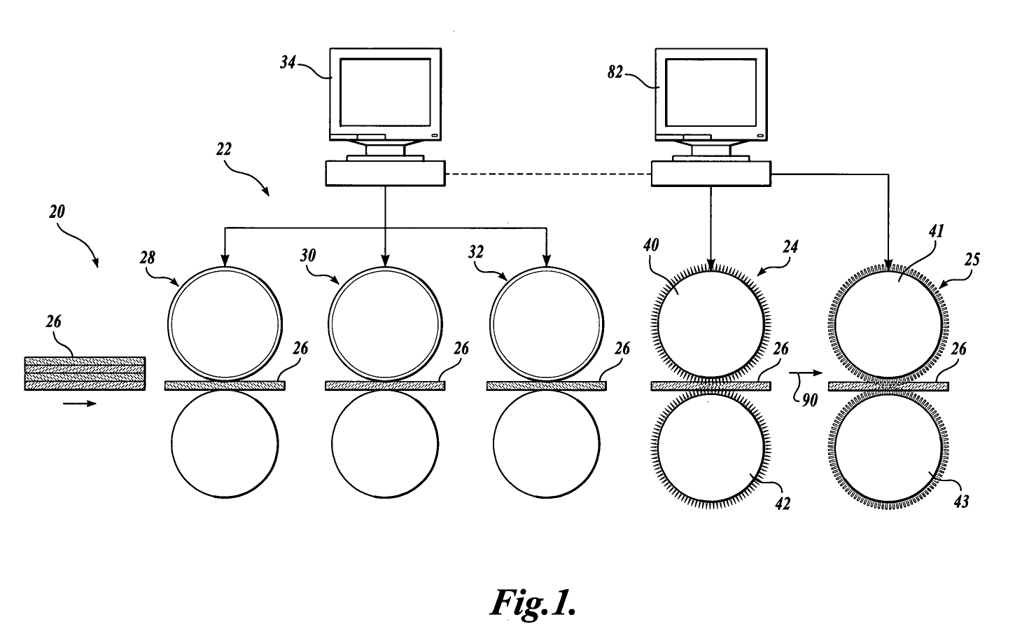

Referring to FIG. 1, a schematic diagram of a box-making machine includes a feed station 20, a printing station 22, a die cutting station 24, and an indenting station 25. A stack of previously cut corrugated boards 26 are shown accumulated at the feeding station. Individual boards 26 are sequentially fed through the printing station 22, the die cutting station 24, and the indenting station 25. In this illustration, the printing station comprises a three-color press including red printing rolls 28, green rolls 30, and blue rolls 32. Red, blue, and green inks, for example, are applied to these three stations to produce a three-color image on the final board issuing from the printing station 22. The printing station 22 is controlled from a processing unit 34 that controls the ink flows, rotation, and registration of the printing press in a conventional manner. Color separations for each ink appear in each printing plate and are used to reproduce the composite image.

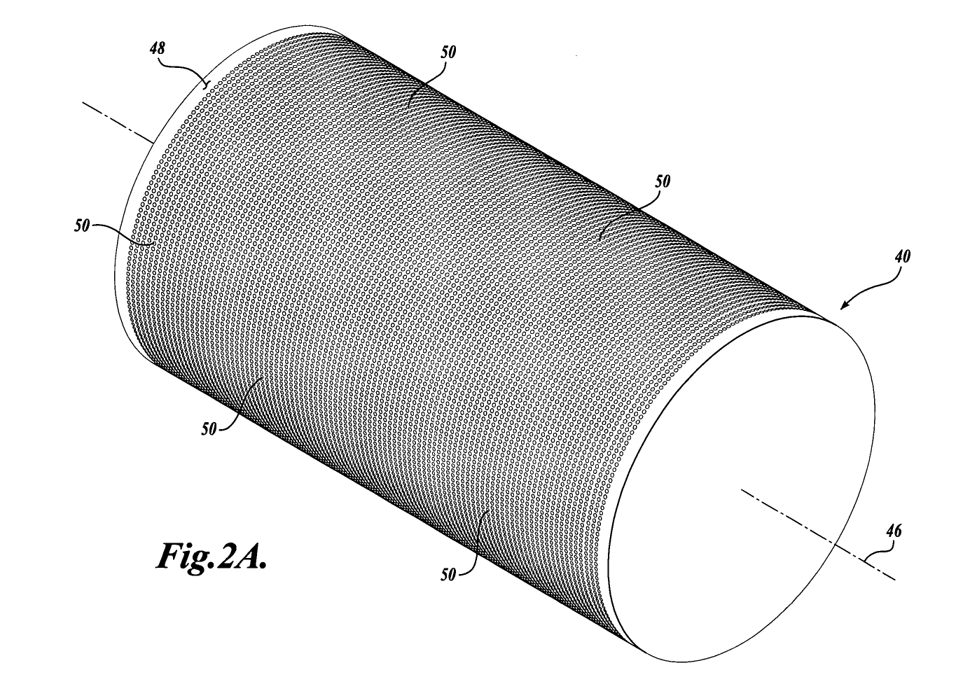

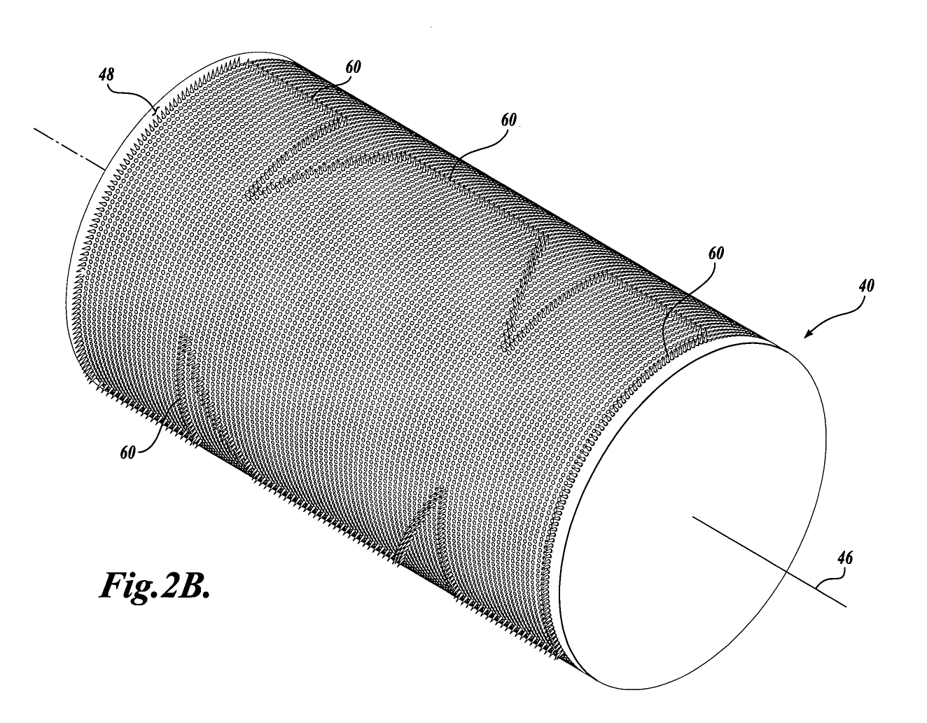

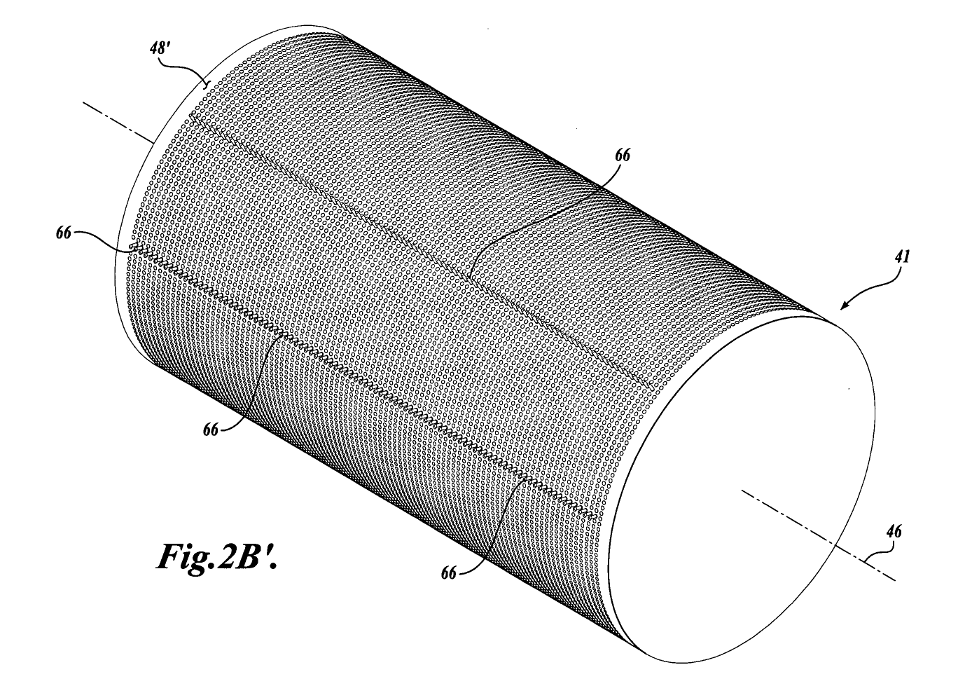

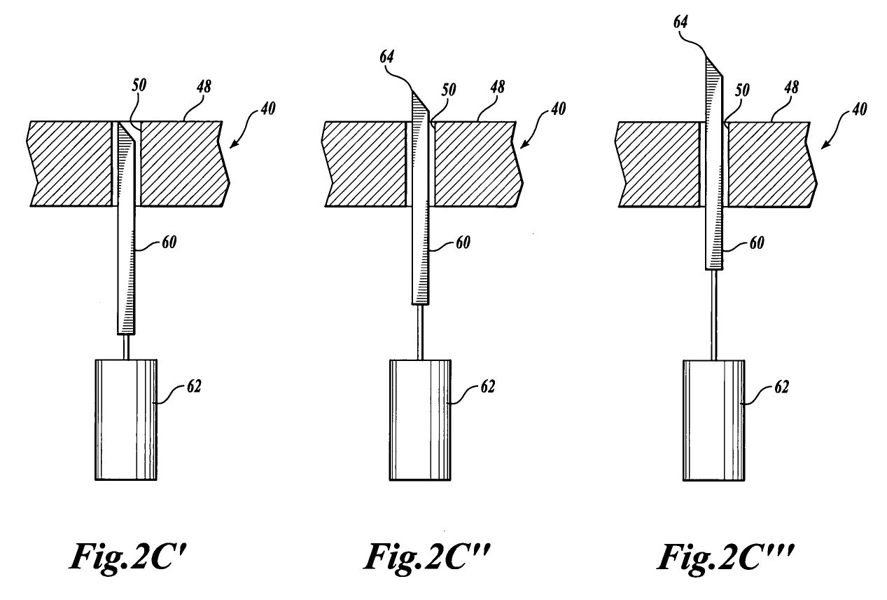

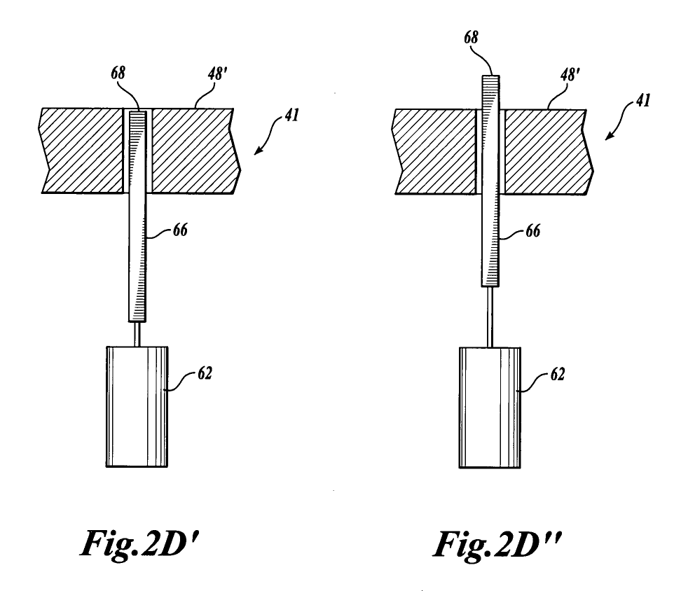

The board 26, upon exiting the printing station, enters the die cutting station and is run between juxtaposed digital die cutters 40 and 42 constructed in accordance with the present invention. In an embodiment, die cutters 40 and 42 may be of virtually identical construction. Referring now to FIG. 2A, a schematic of one of the die cutters 40 is illustrated. In this embodiment, the die cutter 40 comprises a cylinder that may be mounted on its axis of rotation 46. When mounted, the die cutter 40 is properly positioned at the cutting station 24 so that a surface of the die cutter may be presented to the upper surface of the board 26 as the board traverses the advance path 90. The die cutter 40 preferably has a cylindrical surface 48 on which are positioned a plurality of openings 50 or channels that house retractable knives. Preferably the openings, and thus the knives, are arranged in a rectangular array that extends longitudinally across the die cutter 40 and is wrapped circumferentially about the cylindrical surface 48 of the die cutter 40. In an embodiment, these channels or openings would be arrayed at about 8 to 10 per inch (3 to 4 per centimeter), both in the lateral and circumferential direction. The typical length of a die cutting roll 40 would be on the order of 6.3-9.5 feet (1.9-2.9 meters). The typical diameter of a die cutting roll 40 would be on the order of 2-3 feet (0.6-0.9 meters).

An indenting station 25 is positioned downstream from the die cutting station 24. The indenting station has a pair of rolls 41 and 43 of similar construction to die cutter 40, except the indenting rolls carry blunt knives or blades instead of sharp-edged knives. The array of blades in the indenting rolls 41 and 43 may be similar to the array in the die cutting rolls.

Referring to FIG. 2C′, a segment of the surface 48 of the cylinder 40 is shown surrounding a single opening 50. A knife 60 is reciprocally mounted in the opening 50. It is reciprocated by an appropriate actuator 62, such as a pneumatic or hydraulic cylinder, a solenoid actuator, stepping motor, or other suitable mechanical or electrical actuation mechanism. As shown in FIG. 2C″, the knife 60 is shown partially extended to a first position by the actuator 62. The knife 60 has a sharp cutting edge 64 that is capable of penetrating at least one layer of the board as it traverses the die cutting station. In the partially extended position, the cutting edge is located at a predetermined distance above the surface 48. Thus, when the surface 48 is presented to the surface of a board 26, the knife will penetrate the board to the extended depth. It is also contemplated, as shown in FIG. 2C′″, that the knife 60 is extendable to a third position beyond the first position shown in FIG. 2C″. The purpose of these two different positions will be explained in more detail later.

Referring to FIG. 2D′, a second type of knife or blade 66 having a blunt end 68 is shown retracted below a surface 48 of the indenting roll 41. In FIG. 2D″, the knife 66 is shown in a partially extended position. These knives or blades 66 are actuated in a manner similar to the sharp-edged knives 60 shown in FIGS. 2. It is possible that the blunt-edged knife 66 can be actuated so that it is actuated from a retracted position below the surface 48′ of roll 41 to first, second, or even more extended positions depending upon the desired indenting function the knife is to perform.

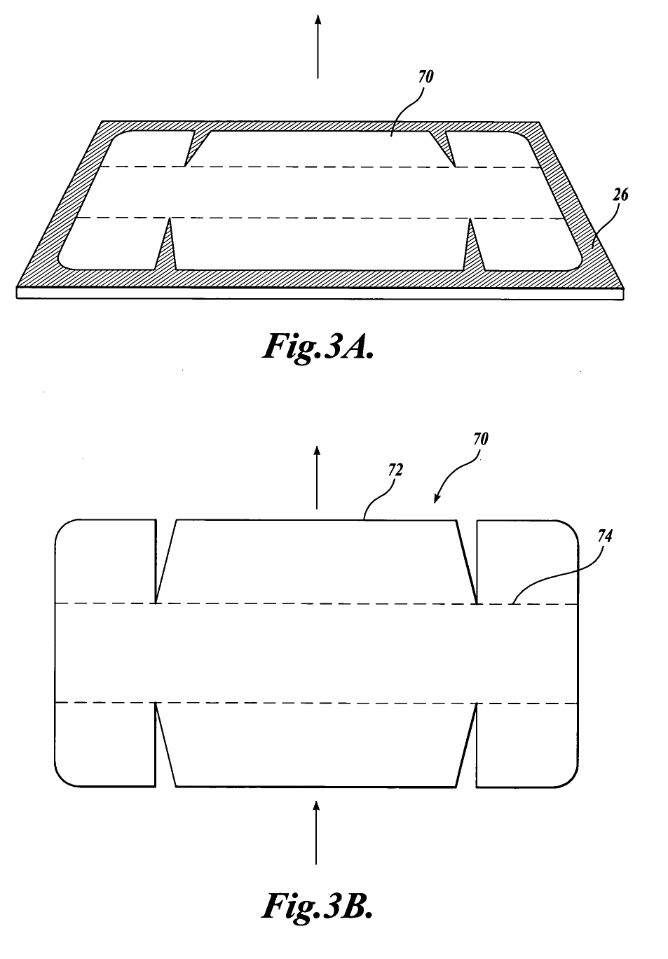

Referring now to FIG. 3B, a typical box blank 70 formed from a corrugated board 26 after it exits the die cutting machine is shown. The solid outline 72 shows the outer edge of the blank 70 while the dashed line 74 represents an indented score line.

Referring to FIG. 3A, the pattern for the blank 70 is shown overlying a corrugated board 26. As will be explained in more detail later, the die cutters 40 and 42 of the present invention has its knives arranged so as to cut the periphery 72 of the blank 70. Referring to FIG. 2B, this is accomplished by partially or fully extending the knives 60 from the array on the cutter 40 so that the knives 60 extend above the surface, for example, as shown in FIG. 2C′″. When the corrugated board is run through the die cutter, the knives 60 will cut along the peripheral portion to form the blank.

Referring to FIG. 2B′, the blades 66 in the indenting roll 41 are similarly extended in a transverse line corresponding to the indented lines 74 in the pattern (FIG. 3A). As the board 26 is fed between the rolls 41, the indented lines will be formed in the board to aid in folding the box into its final shape.

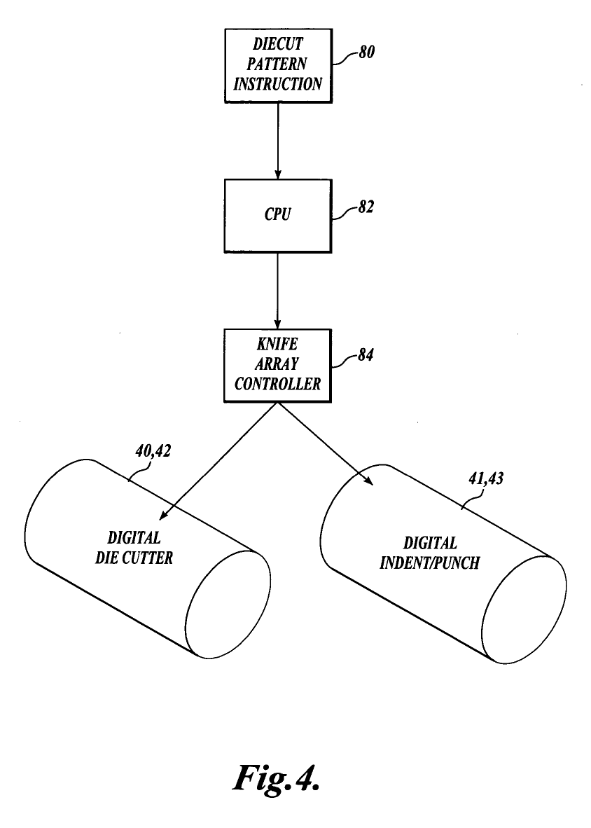

Referring to FIG. 4, the pattern, for example the pattern shown in FIG. 2B, is in the form of a set of computer instructions 80. These instructions would normally be in an image format such as a CAD file (.cad), a bitmap file (.bmp), or other graphics files, such as .tiff or .jpg files. The instructions 80 are then fed to the processing unit of a computer 82 where the image is read and a knife map prepared. The knife map may be in the form of a bitmap file as well. The computer then processes this rasterized image and sends appropriate commands to a controller 84, which in turn addresses the actuators of each knife of the digital die cutters 40 and 42. Where required, the knives would be extended to a first, second, or other position corresponding to the original instructions, while the remaining knives would remain in a retracted state as shown in FIG. 2B. The rasterized image would provide sufficient information to the controller so that not only would the knives be extended to the appropriate height, but that the appropriate knives would be extended to provide cutting action, scoring action, or both. The blunt blades 66 in the roll 41 are similarly extended and set by the controller 84. Alternatively, a completely separate controller may be used.

Once the arrays of knives have been initialized, production of the die cut corrugated board can be initiated. During operation on a given production run, the knife array would remain static. That is, it would behave like a conventional die cutter with no changes in the knife arrangement during a given run. Once a production run of a particular pattern is finished, the knives are reset (retracted) and a new pattern is introduced into the computer 82, instructions are generated for the controller, and a new pattern on the digital die cutter is formed. This reset and repatterning process will take on the order of minutes. This is much less time than is required to reset the printing presses for a new run. Previously, resetting of the die cutter with fixed dies was the limiting factor on turnaround time from one production run to another.

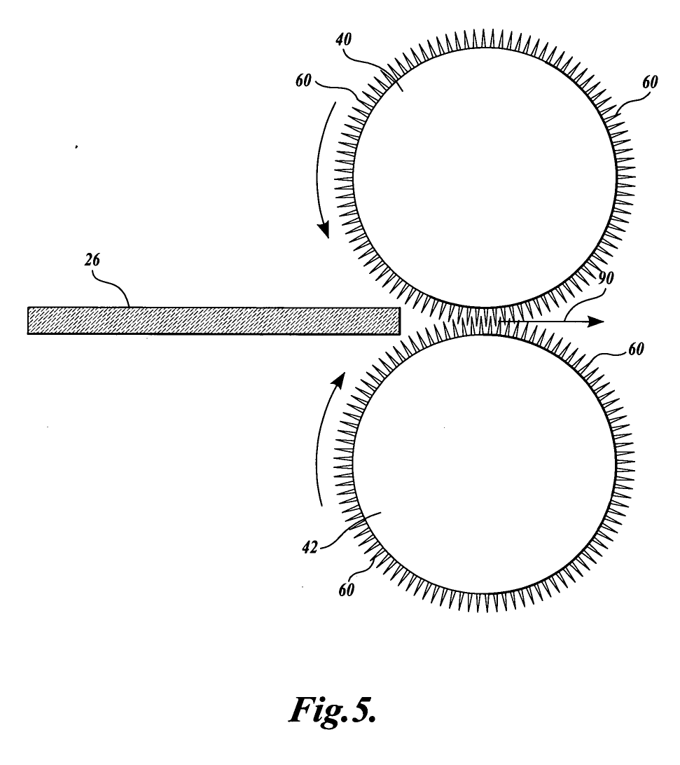

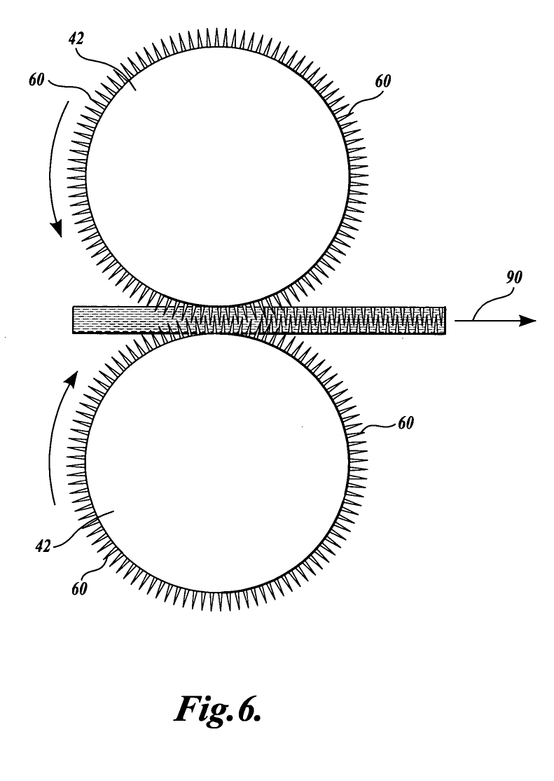

Referring now to FIG. 5, an embodiment of the present invention includes a top die cutter 40 and a bottom die cutter 42. Both of these dies are virtually identical in construction. In FIG. 5 and the ensuing figures, the knives 60 are shown in exaggerated form extending from the die cutters 40 and 42. In reality, the diameter of the die cutters 40 and 42 would be relatively large compared with the extension length of the knives. In FIG. 5, a corrugated board 26 is fed along the advance path 90 between the dies 40 and 42. In FIG. 6, the corrugated board is shown being cut. In this view, the knives are only partially extended so that a perforation or partial cut is formed through the corrugated board. This would result in a perforated line but no complete severing of material from the corrugated board.

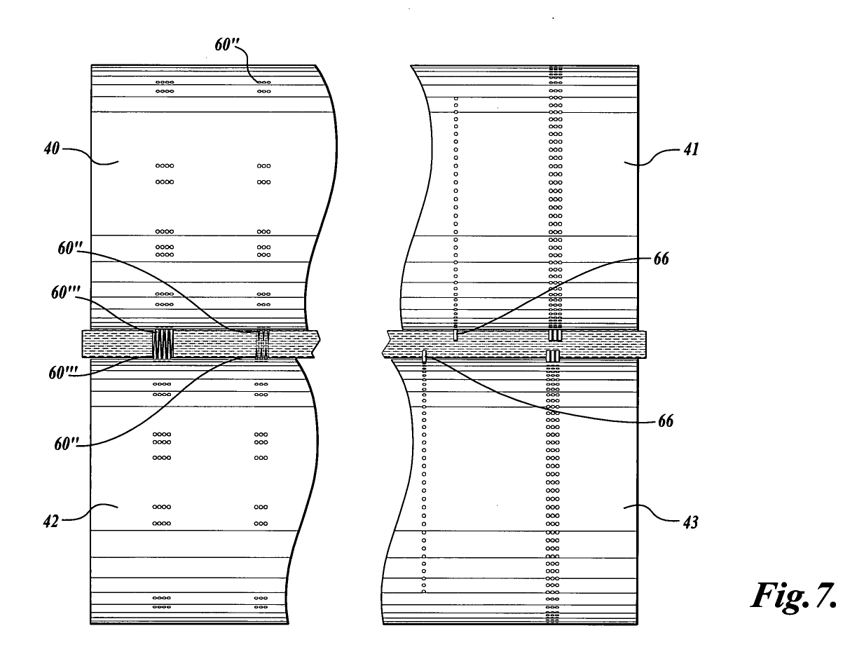

Referring to FIG. 7, different knife sets are shown schematically arranged in different patterns laterally across the two die cutters 40 and 42. (As used herein, laterally means laterally relative to the machine direction and longitudinally (or in the axial direction) along the surface of the die cutter.) Toward the left-hand side, knives 60′″ are shown in a fully extended position. The lateral relationship of the knives on the respective die cutters 40 and 42 are also laterally offset by a distance equal to one-half the distance between the knives in the arrays. This allows the knives 60′″ in the upper die cutter 40 to interleave with the knives 60′″ from the lower die cutter 42. This interrelationship will result in an almost complete severance of material from the corrugated board because each of the knife sets extends almost the entire thickness of the board. This configuration would, for example, be utilized to cut the peripheral portion 72 of the pattern shown in FIG. 3B.

Toward the left center of the die cutters 40 and 42, the knives 60″ are shown only in partial extension. This configuration will result in a perforation or partial cut through the board at spaced locations. Toward the right center of the indenting rolls 41 and 43, blunt-edged knives 66 are shown in a partially extended position. In this position, the surface of the corrugated board is deformed or indented by the blunt knives 66 to produce indents, such as line 74 of FIG. 3A. Toward the right of the cutters 40 and 42, the knives 60 are deployed continuously around the circumference, corresponding to the deployment in FIG. 6. This will provide a continuous perforation, which will allow for easy folding or for later severance by the user of the box. FIG. 7 is intended to provide representative examples of how the knives may be fully or partially extended and the functions of both a knife with a cutting edge and a blunt edge would perform. The die cutter of the present invention can replace conventional rollers to which dies are currently mounted. Thus, much of the existing equipment in a box making machine can be used, significantly reducing the capital expenditures to change to the present invention. In addition, conventional techniques for ejecting waste pieces may be used by mounting high density neoprene pads to the die cutter face. Alternately, a punch for removing waste pieces may be positioned downstream of the die cutter.

It is contemplated within the context of the invention that each knife in the array could itself comprise multiple knives. The knives may be arranged in a variety of patterns so that an angled line in the array would achieve the approximation of a straight line without utilizing an unduly complicated or higher resolution array of knives across the cutters 40 and 42.

While an embodiment of the invention has been illustrated and described, it will be appreciated that various changes can be made therein without departing from the spirit and scope of the invention.

The embodiments of the invention in which an exclusive property or privilege is claimed are defined as follows:

1. A digital die cutter comprising at least a first rotary member having a cylindrically shaped surface and a plurality of knives mounted in an array across and around said surface, each of said knives being extendable in a radial direction to at least a first position above said surface and being retractable below said surface.

2. The die cutter of claim 1, wherein said first member is a cylinder and is mounted for rotation adjacent the path of travel for a panel to be cut or scored, the axis of rotation of said first cylinder being oriented laterally relative to said path.

3. The die cutter of claim 2, further comprising a second cylinder having a cylindrical surface, and a plurality of knives mounted in an array across and around said second surface, each of said knives having a blade extendable in a radial direction to at least a first position above said surface, and being retractable below said surface, and wherein said second cylinder is mounted for rotation adjacent the path of travel for a panel to be cut or scored, the axis of rotation of said second cylinder being oriented laterally relative to said path, said first cylinder mounted to address a first side of said panel, and the said second cylinder being mounted to address a second side of said panel.

4. The die cutter of claim 3, wherein each of the knives in said arrays on said first and second cylinders are equally spaced, laterally and circumferentially, and wherein the array of knives of said first cylinder is offset laterally by a distance equal to half the distance between each knife relative to the array of knives on said second cylinder.

5. The die cutter of claim 1, wherein each knife is extendable to a second position spaced a lesser distance from the surface of said cylinder than said first position.

6. The die cutter of claim 1, wherein at least some of said knives have a cutting edge on the extendable end thereof.

7. The apparatus of claim 1, wherein said knife has a blunt edge on the extendable end thereof.

8. A digital die cutting system comprising:
a first addressable die cutter having a surface, said die cutter further having a plurality of knives arranged in an array on said surface, each of said knives being extendable above and retractable below said surface;
a controller for individually addressing, and extending and retracting said knives above and below said surface;
a central processing unit for receiving an image of a pattern to be cut by selected ones of said knives and for processing said image into signals for said controller to extend selected ones of said knives to correspond to the shape of said pattern; and
means for presenting the surface of said die cutter to one surface of a panel to be die cut when at least some of said knives are extended.

9. The system of claim 8, wherein said pattern has first and second types of images thereon, said knives being extendable to first and second positions, and wherein said processing unit converts said first type of image to first control signals for extending said knives to a first position and for converting said second type of image to control signals for extending said knives to a second position.

10. The system of claim 8, wherein said system comprises a second addressable die cutter having a surface, said second die cutter further having a plurality of knives thereon arranged in an array on said surface, each of said knives being extendable above and retractable below said surface, and wherein said controller is capable of individually extending and retracting said knives associated with said second die cutter above and below the surface of said second die cutter; and
wherein said central processing unit is capable of receiving a second image of a pattern to be cut by selected ones of said knives in said second cutter and for processing said second image into signals for said controller to extend selected one of said knives in said second cutter to correspond to the shape of said second pattern; and
means for presenting the surface of said second die cutter to a second surface of a panel to be die cut when at least some of said knives are extended.

11. The system of claim 8, wherein the surfaces of said first and second die cutters have surfaces shaped as at least a portion of a cylinder, said knives being arranged in a spaced array laterally and circumferentially around said surfaces.

12. The system of claim 11, wherein said first and second die cutters are cylinders and are mounted for rotation about the axis of rotation of said cylinder.

13. The system of claim 12, wherein said axes of rotation are located so as to position said first and second surfaces in juxtaposed relationship respectively relative to the first and second surfaces of a panel moving in a relative path between said die cutters so as to present said surfaces and knives extended therefrom respectively to said first and second surfaces of said panel.

14. The system of claim 11, wherein the knives of said first die cutter are laterally offset from the knives of said second die cutter by a distance equal to one-half the distance between the knives.

15. The system of claim 8, further comprising:
a second addressable die member having a surface, said die member having a plurality of blunt-edged blades arranged in an array on the surface, each of said blades being extendable above and retractable below said surface.
